(19) United States
(12) Patent Application Publication
(10) Pub. No.: US 2007/0292551 A1
(43) Pub. Date: Dec. 20, 2007

(54) Heated scoop utensil for dispensing frozen food products

(76) Inventors: Edgar D. Taylor, Covington, GA (US); Jaison D. Taylor, Covington, GA (US)

Correspondence Address: David O. Simmons;Galasso & Associates LP, P.O. Box 26503, Austin, TX, 78755-0503, US

(21) Appl. No.: 11/455,576

(22) Filed: Jun. 19, 2006

(51) Int. Cl. B28B 1/00

(52) U.S. Cl. 425/277; 425/187; 425/276

(57) ABSTRACT

A heated scooping utensil comprises a handle assembly, a scoop assembly and means for releaseably retaining the handle attachment structure of the scoop body in engagement with the housing. The handle assembly includes a housing and an electrical power supply at least partially contained within an interior space of the housing. The electrical interconnect portion of the electrical power supply is exposed at an exterior surface of the housing. The scoop assembly includes a scoop body and a heating element. The heating element is attached to the scoop body. The scoop body includes a handle attachment structure disengagably engaged with the housing. The heating element includes an electrical interconnect portion disconnectably interconnected with the electrical interconnect portion of the electrical power supply. The means for releaseably retaining the handle attachment structure enables the handle attachment structure of the scoop body to be selectively engaged with and disengaged from the housing.

### FIELD OF THE DISCLOSURE

The disclosures made herein relate generally to utensils for cooking, serving, dispensing and consuming food and, more particularly, to heated scoop utensils for dispensing frozen food products.

### BACKGROUND

Most consumers of frozen food products (such as ice cream) prefer to separate a serving size from the container before consuming it in order to maintain sanitation of the remaining frozen food product and limit the amount consumed. Heretofore, a number of variations of heated scoop utensils (e.g., heated ice cream scoops) have been proposed and/or implemented for the purpose of separating portions of a frozen food product. Through the process of heat conduction, the frozen food product in direct contact with a scoop head portion of the heated scoop utensil is slightly melted increasing the ease of gathering and serving any frozen food product. Several such tools implement the use of electricity to heat the scoop or portions of it.

Known heated scoop utensils are limited in one or more aspects. Examples of such aspects include, but are not limited to, a fixed size scoop, a fixed connection of the scoop to the major electrical components and dependency on a line voltage electrical supply for operation. Therefore, a heated scoop utensil for dispensing frozen food products that overcomes limitations associated with known heated scoop utensils would be advantageous, desirable and useful.

### SUMMARY OF THE DISCLOSURE

In one embodiment of the present invention, a heated scooping utensil comprises a handle assembly, a scoop assembly and means for releaseably retaining the handle attachment structure of the scoop body in engagement with the handler assembly. The handle assembly includes a housing and an electrical power supply at least partially contained within an interior space of the housing. An electrical interconnect portion of the electrical power supply is exposed at an exterior surface of the housing. The scoop assembly includes a scoop body and a heating element. The heating element is attached to the scoop body. The scoop body includes a handle attachment structure disengagably engaged with the housing. The heating element includes an electrical interconnect portion disconnectably interconnected with the electrical interconnect portion of the electrical power supply. The means for releaseably retaining the handle attachment structure enables the handle attachment structure of the scoop body to be selectively engaged with and disengaged from the housing.

In another embodiment of the present invention, a heated scooping utensil comprises a housing, an electrical power supply, a scoop body, a heating element, a retention device, and means for limiting rotation of the scoop body with respect to the handle assembly. The housing includes a receptacle therein. The electrical power supply is at least partially contained within an interior space of the housing. The scoop body includes a handle attachment structure positioned within the receptacle of the housing. The heating element is attached to the scoop body. The retention device is engaged between the housing and a retention feature of the handle attachment structure of the scoop body. The means for limiting rotation of the scoop body with respect to the housing when the handle attachment structure is located within the receptacle. An electrical interconnect portion of the electrical power supply is exposed within the receptacle of the housing. The heating element includes an electrical interconnect portion disconnectably interconnected with the electrical interconnect portion of the electrical power supply. The retention device enables the handle attachment structure of the scoop body to be selectively secured within and removed from within the receptacle of the housing.

In another embodiment of the present invention, a heated scooping utensil kit comprises a handle assembly and a plurality of scoop assemblies. The handle assembly includes a housing and an electrical power supply at least partially contained within an interior space of the housing. The electrical interconnect portion of the electrical power supply is exposed at an exterior surface of the housing. Each one of the scoop assemblies includes a scoop body and a heating element attached to the scoop body. The scoop body of each one of the scoops has a respective scoop body head of a different diameter. The scoop body of each one of the scoop assemblies includes a handle attachment structure engagable with the housing. The heating element of each one of the scoop assemblies includes an electrical interconnect portion disconnectably interconnectable with the electrical interconnect portion of the electrical power supply when the handle attachment structure is engaged with the housing.

Turning now to specific aspects of the present invention, in at least one embodiment, a retention device is attached to the housing of the handle assembly and is disengagably engagable with a retention feature of the handle attachment structure of each one of the scoop assemblies for enabling each one of the scoop assemblies to be selectively engaged with and disengaged with the housing.

In at least one embodiment of the present invention, means is provided for limiting rotation of the scoop assembly with respect to the handle assembly when the handle attachment structure is engaged with the housing.

In at least one embodiment of the present invention, the housing includes a receptacle therein, the handle attachment structure of the scoop body is positioned in the receptacle and the electrical interconnect portion of the electrical power supply is exposed within the receptacle.

In at least one embodiment of the present invention, the heating element is within a cavity within the scoop body.

In at least one embodiment of the present invention, the scoop body includes a scoop body head and an extension segment, a first end portion of the extension segment is attached to the scoop body head and a second end portion of the extension segment includes the handle attachment structure.

In at least one embodiment of the present invention, the heating element is within, the extension segment, the housing including a receptacle therein, the handle attachment structure of the scoop body is positioned in the receptacle, and the electrical interconnect portion of the electrical power supply is exposed within the receptacle.

In at least one embodiment of the present invention, means is provided for enabling an output power supplied from the electrical power supply to be selectively adjusted such that a heat output of the heating element is selectively adjustable.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a front illustrative view of an embodiment of a heated scooping utensil in accordance with the present invention.

FIG. 2 is a cross-sectional view taken along the line 2-2 in FIG. 1.

FIG. 3 is a front illustrative view of a plurality of different configuration scoop assemblies in accordance with the present invention.

### DETAILED DESCRIPTION OF THE DRAWING FIGURES

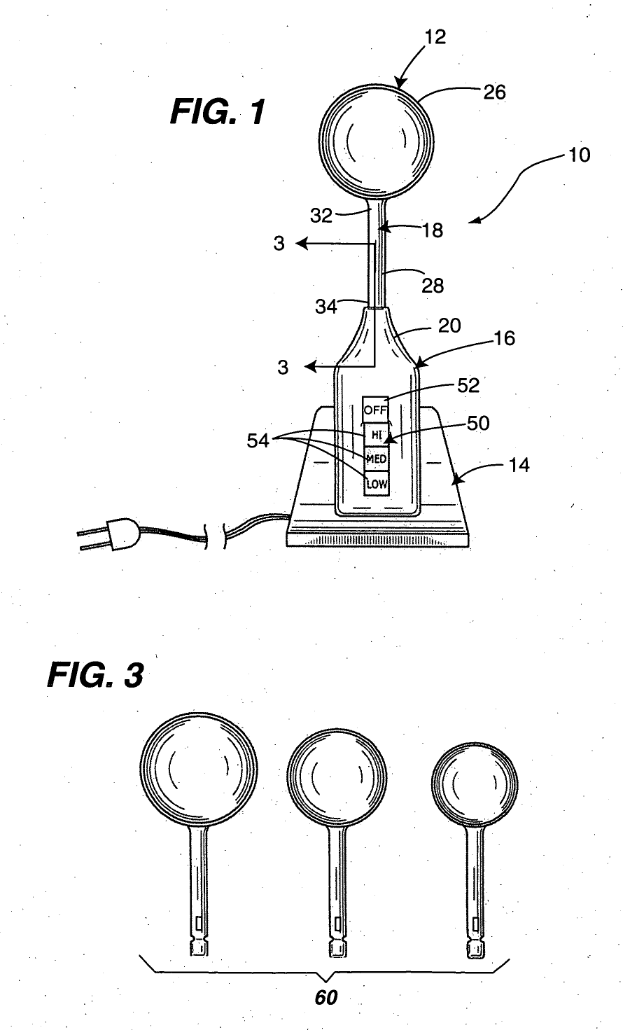

FIGS. 1 show an embodiment of a heated scooping utensil system in accordance with the present invention, which is referred to herein as the heated scooping utensil 10. Through the process of heat conduction, the heated scooping apparatus 10 enables a frozen food product to be melted for increasing the ease of gathering and serving the frozen food product (e.g., a scoop of ice cream). The heated scooping utensil system 10 is advantageous, desirable and useful in that it overcomes one or more limitations of conventional heated scooping utensils.

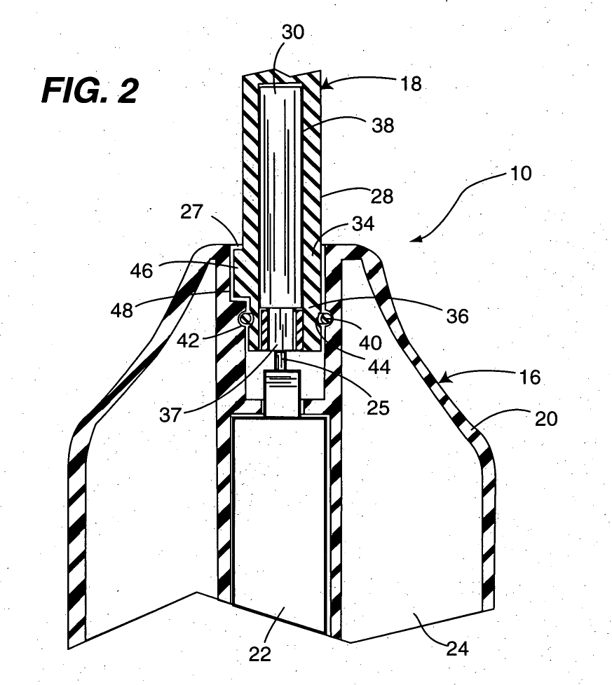

Referring now to FIGS. 1-2, the heated scooping utensil system 10 includes a heated scoop utensil 12 and a charging base 14. The heated scoop utensil 12 includes a handle assembly 16 and a scoop assembly 18. The handle assembly 16 is structurally and electrically engaged with a mating portion of the scoop assembly 18. The handle assembly 16 is structurally and electrically engaged with a mating portion of the charging base 14. As is discussed below in greater detail, the charging base 14 provides electrical power to the heated scooping utensil 12 and the heated scooping utensil 12 is configured for generating heat to melt a frozen food product while scooping the frozen food product.

The handle assembly 16 includes a housing 20 and an electrical power supply 22 (FIG. 3) at least partially contained within an interior space 24 of the housing 20. An electrical interconnect portion 25 (FIG. 2) of the electrical power supply 22 is exposed within a receptacle 27 of the housing 20 and the receptacle is generally comprised of one or more exterior surfaces of the housing 20. A battery is one example of the electrical power supply 22. In the case where the electrical power supply 22 is a battery, the battery is preferably a rechargeable battery that received recharge current from the charging base 14. In one embodiment, the charging base 14 receives electrical power from a line-voltage source (e.g., a wall outlet) and converts such line-voltage electrical power to a suitably regulated direct-current power. In another embodiment, the charging base receives direct current power and supplies it in an as is form or converted form. It is disclosed herein that any number of known electrical contact structures may be used from providing the electrical charging current from the charging base 14 to the electrical power supply 22. In general, a similar electrical contact structure as used in known cordless phones may be used for establishing electrical continuity between the heated scooping utensil 12 and the charging base 14.

The scoop assembly 18 includes a scoop body head 26, an extension segment 28 and a heating element 30 (FIG. 2). The scoop body head 26 and the extension segment 28 jointly define a scoop body. A first end portion 32 of the extension segment 28 is attached to the scoop body head 26. A second end portion 34 of the extension segment 28 includes a handle attachment structure 36 (FIG. 2). The handle attachment structure 36 is positioned in the receptacle 27. The heating element 30 includes an electrical interconnect portion 37 disconnectably interconnected with the electrical interconnect portion 25 of the electrical power supply 22 when the scoop assembly 18 is engaged with the handle assembly 16. In one embodiment, the electrical interconnect portion 37 of the heating element 30 includes two electrically insulated electrical contacts and the electrical interconnect portion 25 of the electrical power supply 22 includes two electrically insulated electrical contacts. Each one of the contacts of the heating element 30 mates with a respective one of the two electrically insulated electrical contacts of the electrical power supply 22 for enabling the transmission of electrical current between the heating element 30 and the electrical power supply 22. As is discussed below in greater detail, the handle attachment structure 36 provides for structural interconnection of the scoop assembly 18 with the handle assembly 16 and for selectively disengagable engagement of the scoop assembly 18 with the handle assembly 16.

The heating element 30 is retained within a cavity 38 of the extension segment 28. In the depicted embodiment, the scoop head body 26 and the extension segment 28 are integrally formed from a thermally conductive material (e.g., aluminium, stainless steel, etc) such that heat generated by the heating element 30 is conducted to the scoop body head 26. In other embodiments, not shown, the heating element may be integral with the scoop body head. U.S. Pat. No. 4,553,921; U.S. Pat. No. 3,513,290; and United State statutory invention registration no. H846, which are each incorporated herein by reference, disclose various implementations of a heating element integral with a scoop body head of a heated scooping utensil.

As shown in FIG. 2, a retention clip 40 is jointly engaged within a groove 42 of the receptacle 27 and a groove 44 of the handle attachment structure 36. The retention clip 40, groove 42 of the receptacle 27 and groove 44 of the handle attachment structure 36 is an embodiment of a means for releaseably retaining the handle attachment structure 36 of the scoop assembly 18 in engagement with the housing 20. Such a means for releaseably retaining enables the handle attachment structure 36 of the scoop assembly 18 to be selectively engaged with and disengaged from the housing 20. It is disclosed herein that other embodiments of retentions devices that serves as a means for releaseably retaining the handle attachment structure 36 of the scoop assembly 18 in engagement with the housing 20 may be implemented. An example of such another retention device is a locking pin retractably mounted on the housing 20 that is biased into engagement with the groove 44 of the handle attachment structure 36. In view of the disclosures made herein, a skilled person will contemplate other embodiments of such means.

The handle attachment structure 36 of the scoop assembly 18 includes a tab 46 that is engaged with a slot 48 of the receptacle 27. The tab 46 and the slot 48 jointly serve as a means for limiting rotation of the scoop assembly 18 with respect to the handle assembly 16 when the handle attachment structure 36 is engaged with the housing 20. The anti-rotation functionality is beneficial in that it limiting rotation of the scoop assembly 18 with respect to the handle assembly 16 enhances ones ability to forcefully and controllably engage the scoop assembly into a mass of frozen food product (e.g., ice cream). In view of the disclosures made herein, a skilled person will contemplate various other specific structures for providing such anti-rotation functionality.

As shown in FIG. 1, a control switch 50 is mounted on the housing 20. The control switch 50 includes an ‘off’ control button 52 and a plurality of heat output buttons 54. When the ‘off’ control button 52 is selected, the generation of heat by the heating element 30 is precluded (e.g., opens an electrical circuit between the heating elopement 30 and the electrical power supply 22). When any one of the heat output buttons 54 is selected, a respective degree of heat is generated by the heating element 30 (e.g., a relatively low heat level, a relatively medium heat level and a relatively high heat level). The control switch 50 is an embodiment of a means for enabling an output power supplied from the electrical power supply to be selectively adjusted such that a heat output of the heating element is selectively adjustable. More broadly, the control switch 50 is an embodiment of a means for enabling a heat output level of the heating element to be selectively adjusted.

Referring now to FIG. 3, a set 60 of scoop assemblies in accordance with the present invention are shown. Each one of the scoop assemblies of the set 60 is essentially the same in overall structural and electrical construction as the scoop assembly shown in FIGS. 1 and 2. However, each one of the scoop assemblies of the set 60 has a different scoop head size (e.g., volume and/or diameter). In this manner, the scoop assemblies of the set 60 jointly provide a means of scooping different volumes of a frozen food product. Such functionality is beneficial when serving frozen food product in a commercial establishment (e.g., serving size control) and when extracting frozen food product from different size containers. A heated scooping utensil kit in accordance with the present invention includes a handle assembly in accordance with the present invention (e.g., the handle assembly 16 of FIGS. 1 and 2) and a set of scoop assemblies in accordance with the present invention (e.g., the set 60 of scoop assemblies shown in FIG. 3).

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A heated scooping utensil, comprising:
a handle assembly including a housing and an electrical power supply at least partially contained within an interior space of the housing, wherein an electrical interconnect portion of the electrical power supply is exposed at an exterior surface of the housing;
a scoop assembly including a scoop body and a heating element, wherein the heating element is attached to the scoop body, wherein the scoop body includes a handle attachment structure disengagably engaged with the housing and wherein the heating element includes an electrical interconnect portion disconnectably interconnected with the electrical interconnect portion of the electrical power supply; and
means for releaseably retaining the handle attachment structure of the scoop body in engagement with the housing, wherein said means for releaseably retaining enables the handle attachment structure of the scoop body to be selectively engaged with and disengaged from the housing.

2. The heated scooping utensil of claim 1, further comprising:
means for limiting rotation of the scoop assembly with respect to the handle assembly when the handle attachment structure is engaged with the housing.

3. The heated scooping utensil of claim 2 wherein:
the housing includes a receptacle therein;
the handle attachment structure of the scoop body is positioned in the receptacle; and
the electrical interconnect portion of the electrical power supply is exposed within the receptacle.

4. Thee heated scooping utensil of claim 1 wherein:
the housing includes a receptacle therein;
the handle attachment structure of the scoop body is positioned in the receptacle; and
the electrical interconnect portion of the electrical power supply is exposed within the receptacle.

5. The heated scooping utensil of claim 1 wherein, the heating element is within a cavity within the scoop body.

6. The heated scooping utensil of claim 1 wherein:
the scoop body includes a scoop body head and an extension segment;
a first end portion of the extension segment is attached to the scoop body head; and
a second end portion of the extension segment includes the handle attachment structure.

7. The heated scooping utensil of claim 6 wherein:
the heating element is within the extension segment;
the housing includes a receptacle therein;
the handle attachment structure of the scoop body is positioned in the receptacle; and
the electrical interconnect portion of the electrical power supply is exposed within the receptacle.

8. The heated scooping utensil of claim 7 wherein said means for releaseably retaining includes a retention member engaged between the housing and a mating feature of the handle attachment structure.

9. A heated scooping utensil, comprising:
a housing including a receptacle therein,
an electrical power supply at least partially contained within an interior space of the housing, wherein an electrical interconnect portion of the electrical power supply is exposed within the receptacle of the housing;
a scoop body including a handle attachment structure positioned within the receptacle of the housing;
a heating element attached to the scoop body, wherein the heating element includes an electrical interconnect portion disconnectably interconnected with the electrical interconnect portion of the electrical power supply;
a retention device engaged between the housing and a retention feature of the handle attachment structure of the scoop body for enabling the handle attachment structure of the scoop body to be selectively secured within and removed from within the receptacle of the housing; and
means for limiting rotation of the scoop body with respect to the housing when the handle attachment structure is within the receptacle.

10. The heated scooping utensil of claim 9 wherein the heating element is within a cavity within the scoop body.

11. The heated scooping utensil of claim 9 wherein:
the scoop body includes a scoop body head and an extension segment;
a first end portion of the extension segment is attached to the scoop body head; and
a second end portion of the extension segment includes the handle attachment structure.

12. The heated scooping utensil of claim 11 wherein the heating element is within a cavity of the extension segment.

13. The heated scooping utensil of claim 12 wherein the retention device includes a retention member that engages a mating feature of the handle attachment structure.

14. The heated scooping utensil of claim 13, further comprising:
means for enabling an output power supplied from the electrical power supply to be selectively adjusted such that a heat output of the heating element is selectively adjustable.

15. A heated scooping utensil kit, comprising:
a handle assembly including a housing and an electrical power supply at least partially contained within an interior space of the housing, wherein an electrical interconnect portion of the electrical power supply is exposed at an exterior surface of the housing; and
a plurality of scoop assemblies each including a scoop body and a heating element attached to the scoop body, wherein the scoop body of each one of said scoops has a respective scoop body head of a different diameter, wherein the scoop body of each one of said scoop assemblies includes a handle attachment structure engagable with the housing and wherein the heating element of each one of said scoop assemblies includes an electrical interconnect portion disconnectably interconnectable with the electrical interconnect portion of the electrical power supply when the handle attachment structure is engaged with the housing.

16. The heated scooping utensil of claim 15, further comprising:
a retention device attached to the housing of the handle assembly, wherein the retention device is disengagably engagable with a retention feature of the handle attachment structure of each one of the scoop assemblies for enabling each one of said scoop assemblies to be selectively engaged with and disengaged with the housing.

17. The heated scooping utensil of claim 16 wherein:
the handle attachment structure of each one of said scoop assemblies includes an anti-rotation feature; and
the handle assembly includes an anti-rotation feature that mates with the anti-rotation feature of the handle attachment structure for limiting rotation of the scoop assembly with respect to the handle assembly when the handle attachment structure is engaged with the housing.

18. The heated scooping utensil of claim 17 wherein:
the housing includes a receptacle therein;
the handle attachment structure of each one of the scoop assemblies is individually positionable within the receptacle; and
the electrical interconnect portion of the electrical power supply is exposed within the receptacle

19. The heated scooping utensil of claim 18 wherein the heating element is within a cavity within the scoop body.

20. The heated scooping utensil of claim 19 wherein:
the scoop body includes a scoop body head and an extension segment;
a first end portion of the extension segment is attached to the scoop body head;
a second end portion of the extension segment includes the handle attachment structure; and
the cavity is within the extension segment.
